(19) United States
(12) Patent Application Publication
(10) Pub. No.: US 2007/0050152 A1
(43) Pub. Date: Mar. 1, 2007

(54) Protein Structure Determination

(75) Inventors: Raymond C. Stevens, La Jolla, CA (US); Peter Kuhn, Solana Beach, CA (US); Maneesh Yadav, San Diego, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: The Scripps Research Institute

(21) Appl. No.: 11/510,422

(22) Filed: Aug. 24, 2006

Related U.S. Application Data
(60) Provisional application No. 60/710,747, filed on Aug. 24, 2005.

(51) Int. Cl. G06F 19/00

(52) U.S. Cl. 702/19

(57) ABSTRACT

A method is provided for acquiring X-ray diffraction images of a protein crystal, the method comprising providing an X-ray source and a micro-channel, wherein the micro-channel contains an oil, gas or immiscible liquid and at least one aqueous droplet comprising a crystal of a protein, recording an X-ray diffraction image of the crystal, repositioning the crystal with respect to the X-ray source, and repeating the last two steps immediately above at least once.

### CROSS-REFERENCE TO RELATED APPLICATIONS

This application claims priority from U.S. Provisional Application Ser. No. 60/710,747 filed on Aug. 24, 2005, which is incorporated herein by reference in its entirety.

### STATEMENT REGARDING FEDERALLY SPONSORED RESEARCH OR DEVELOPMENT

This work was supported at least in part with funds from the U.S. Government under U.S.P.H.S. Grants Y1-CO-1020 awarded by the National Cancer Institute, Y1-GM-1 104 awarded by the National Institute of General Medical Sciences, GM073197 EB001903 awarded by the National Institutes of Health, and under Contract No. W-31-109-Eng-38 from the U.S. Department of Energy. The U.S. Government has certain rights in the invention.

### INCORPORATION-BY-REFERENCE OF MATERIAL SUBMITTED ON A COMPACT DISC

Not Applicable.

### BACKGROUND

Current methods of obtaining X-ray diffraction data from macromolecular crystals for determining the three-dimensional structure of the macromolecule traditionally involve manual crystal handling or slow crystallization processes which can be inefficient, awkward and difficult. For example, mechanical shock damage to a crystal can be difficult to avoid when a researcher positions a crystal in an X-ray imaging apparatus using current methods.

Zheng et al., Adv. Mater. 2004 16:1365-1368, have previously formed crystals in aqueous droplets and visualized those crystals. However, Zheng did not obtain data sufficient to allow protein structure determination, and instead proposed a method for determining crystal quality.

Accordingly, there is a need for alternative methods and systems for obtaining X-ray diffraction data from protein crystals.

### SUMMARY

The inventors disclose herein methods for acquiring X-ray diffraction images for determining three-dimensional structure of a protein. In various aspects, these methods comprise providing an X-ray source and a micro-channel, wherein the micro-channel contains an aqueous droplet comprising a crystal of the protein and an oil, gas, or immiscible liquid, and recording an X-ray diffraction image the crystal. The protein crystal is then repositioned with respect to the X-ray source, and an additional X-ray diffraction image is recorded. The repositioning and the imaging are then repeated at least once.

In various alternative aspects, the methods for acquiring X-ray diffraction images of a protein crystal comprise providing an X-ray source and a micro-channel, wherein the micro-channel contains at least two aqueous droplets and an oil, gas or immiscible liquid, further wherein each droplet comprises a protein crystal; recording an X-ray diffraction image of a first protein crystal comprised by the micro-channel repositioning the micro-channel with respect to the X-ray source such that a second or greater protein crystal comprised by the micro-channel is subjected to the X-ray source; recording an X-ray diffraction image of the second or greater protein crystal comprised by the micro-channel; and repeating the repositioning and the recording at least once.

In certain other aspects, the inventors disclose methods for determining a three dimensional structure of a protein. In these aspects, the methods comprise providing an X-ray source and a micro-channel, the micro-channel containing at least one aqueous droplet comprising a crystal of a protein and an oil, gas or immiscible liquid; recording an X-ray diffraction image of the crystal; repositioning the crystal with respect to the X-ray source; repeating the recording and the repositioning at least once; and transforming the X-ray diffraction images to assign coordinates to atoms comprised by the protein.

In yet other aspects, the inventors disclose methods for designing a drug. These methods comprise providing an X-ray source and a micro-channel, wherein the micro-channel contains at least one aqueous droplet comprising a crystal of a protein and an oil, gas or immiscible liquid; recording an X-ray diffraction image of the crystal; repositioning the crystal with respect to the X-ray source; repeating the recording and the repositioning at least once; transforming the X-ray diffraction images to assign coordinates to atoms comprised by the protein; representing the atoms in a three dimensional structure in a digital computer; and using software comprised by the digital computer to design a chemical compound which is predicted to bind to the protein.

In other aspects, the inventors disclose methods for acquiring X-ray diffraction images of a crystal of a protein-ligand complex. These methods comprise providing an X-ray source and a micro-channel, wherein the micro-channel contains at least one aqueous droplet comprising a crystal of a protein-ligand complex and an oil, gas or immiscible liquid; recording an X-ray diffraction image of the crystal; repositioning the crystal with respect to the X-ray source; and repeating the recording and the repositioning at least once.

In various aspects, the repositioning the protein crystal with respect to the X-ray source can comprise rotating the protein crystal with respect to the X-ray source by a predetermined amount. The rotating can comprise, in non-limiting example, rotating the crystal about 1°. In addition, the X-ray diffraction images can comprise at least about 10 X-ray diffraction images, or at least 51 X-ray diffraction images. In some configurations, the repositioning the protein crystal with respect to the X-ray source by a predetermined amount can comprise rotating the micro-channel by a predetermined amount.

In various configurations, the positioning, the recording, and/or the repositioning can occur at a temperature between about 0° C. and 30° C. .

In various configurations of the disclosed methods, at least 2, at least about 5, at least about 10, at least about 15, at least about 20, at least about 25, at least about 30, at least about 35, at least about 40, at least about 45, at least about 50, or at least 51 X-ray diffraction images can be recorded from a single crystal.

In various configurations of the disclosed methods, at least 2, at least about 5, at least about 10, at least about 15, at least about 20, at least about 25, at least about 30, at least about 35, at least about 40, at least about 45, at least about 50, or at least 51 X-ray diffraction images can be recorded from crystals in a single micro-channel.

In another aspect, the present teaching discloses a method wherein the positioning, recording, and/or repositioning, is conducted at a temperature between about −170° C. and about 30° C. , about −120° C. and about 20° C. , about −80° C. and about 10° C. , or about 0° C. and about 4° C. .

A plastic micro-channel is also provided comprising two or more aqueous droplets comprising protein crystals separated by an oil, gas or immiscible liquid. The plastic can be selected from the group consisting of COP, COC, PMMA, acrylic, polystyrene, polycarbonate and NAS. In various embodiments, in addition to at least two crystals separated by an oil, at least one additional aqueous droplet comprising a protein crystal can be separated by a gas. In various embodiments, in addition to at least two crystals separated by an oil, at least one additional aqueous droplet comprising a protein crystal can be separated by an immiscible liquid. In various embodiments, in addition to at least two crystals separated by an gas, at least one additional aqueous droplet comprising a protein crystal can be separated by an immiscible liquid. In various embodiments, in addition to at least two crystals separated by an oil, at least one additional crystal can be separated by a different oil. In various embodiments, in addition to at least two crystals separated by an immiscible liquid, at least one additional crystal can be separated by a different immiscible liquid. In various embodiments, in addition to at least two crystals separated by a gas, at least one additional crystal can be separated by a different gas. In various aspects, the at least two crystals can comprise the same or different macromolecules.

These and other features, aspects and advantages of the present invention will become better understood with reference to the following description, examples and appended claims.

### DRAWINGS

FIG. 1. A photomicrograph of two thaumatin crystals inside two separate plugs in the micro-channel.

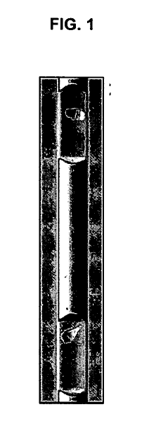

FIG. 2. Initial in situ diffraction image from a dataset of thaumatin crystal taken in a micro-channel. The frame parameters were 1.0° oscillation, 1.2 s exposure, and detector distance of 150 mm.

FIG. 3. Decreasing intensity signals of both crystals as X-ray dose accumulates.

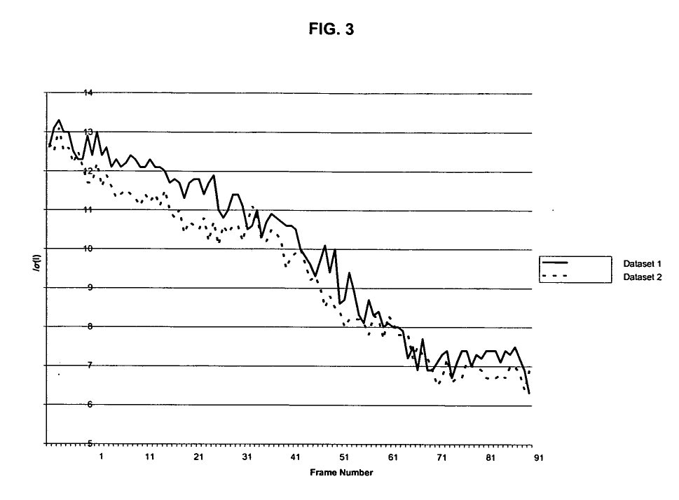

FIG. 4. Increasing mosaicities of both crystals as X-ray dose accumulates.

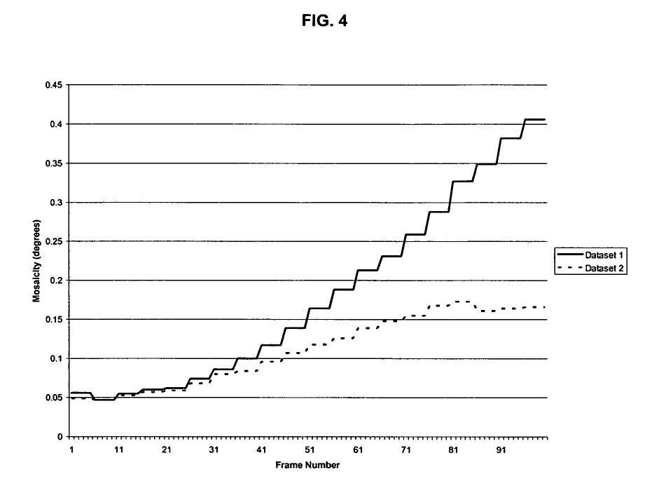

FIG. 5. Electron density map of thaumatin from merged dataset. Figures generated using Pymol (DeLano Scientific, San Carlos, Calif.).

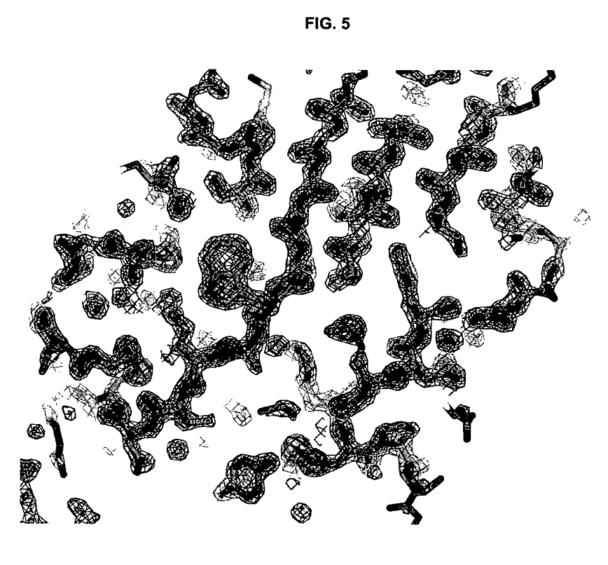

FIG. 6. This figure depicts the smooth background of the COP plastic and glass micro-channels (top panels) and the higher intensity provided by a plastic micro-channel, in this case COP plastic tubing, when compared to glass (bottom panel).

FIG. 7. This figure depicts the homogeneity of background scattering when comparing glass, Teflon®, and COP plastic.

FIG. 8. This figure depicts the resolution quality when comparing glass, Teflon® and COP plastic.

FIG. 9. This figure depicts crystals in a micro-channel, in this case COP plastic tubing, and the crystal images provided by in situ X-ray irradiation and image collection. The tubing on the left panel shows two crysals of lysozyme in the COP tubing and the right panel shows a single thaumatin crystal.

### DETAILED DESCRIPTION

To facilitate understanding of the invention, a number of terms and abbreviations as used herein are defined below as follows:

X-ray diffraction image: As used herein, the term “X-ray diffraction image” refers to a single dataset produced from collecting diffracted X-rays from a crystallized protein. These images are compiled and analyzed in order to determine crystal structure.

Micro-channel: As used herein, the term “micro-channel” is broadly defined to include any channel in any shape capable of confining a liquid with minimal turbulence, minimal water permeability and maximum X-ray transparency and diffuse X-ray scatter. A channel may have two or more surfaces in which case the largest distance between surfaces is less than 5 millimeters. A micro-channel, such as a micro-capillary, can also have a single contiguous surface in which case the largest diameter is less than 5 mm. Of specific interest in the invention are those micro-capillaries described in Zheng et al., 2004b.

Crystal: As used herein, the term “crystal” is broadly defined to include any largely homogenous solid formed by a repeating, three-dimensional pattern of atoms, ions, or molecules and having fixed distances between constituent parts. Crystals which are utilized in the present teachings can comprise a protein molecule.

Subjecting a protein to an X-ray source: Subjecting a protein to an X-ray source includes, but is not limited to, placing a protein crystal in an X-ray source wherein the crystal is exposed to X-rays.

X-ray source: As used herein an “X-ray source” creates a relatively high energy photon with a wavelength between about 0.01 and 10 nanometers.

Protein-ligand complex: As used herein, “protein-ligand complex” includes, but is not limited to, a protein-drug combination, an antibody-antigen complex, and proteins complexed with any other protein or non-proteinaceous compound.

Oil: As used herein, the term “oil” includes hydrophobic liquids, including semipermeable hydrophobic liquids, between the aqueous droplets and nonpermeable hydrophobic liquids provided as the plugs.

Semipermeable: As used herein, the term “semipermeable” refers to an oil which is permeable to water (or other solvent) but substantially impermeable to solutes.

Protein Structure Determination

The present invention relates to the discovery of the three-dimensional structure of a protein. These structures are used, for example, in methods of structure-based drug design using such structures, as well as the determination of biological function. The compounds identified by such methods and the use of such compounds in therapeutic compositions are important for drug design studies. In particular, the present invention relates to methods of production of a crystal and the determination of the three dimensional coordinates thereof, particularly in a micro-channel. The demonstration of micro-channel-based crystallization, and the determination of the structure thereof, has the advantage of convenient in situ data collection, significantly reduced cost of production, removal of human errors in handling crystals, faster processing, and increased throughput in discovery of three dimensional structures.

In various aspects, a method is provided for obtaining a structure of a protein, the method comprising providing a micro-channel containing an oil, gas or immiscible liquid, wherein the oil, gas or immiscible liquid comprises aqueous droplets, the droplets further comprising the crystallized protein, subjecting the protein to an X-ray source; obtaining a first diffraction image, rotating the protein with respect to the X-ray source, and obtaining a second diffraction image. The invention also provides for repositioning the crystallized protein with respect to the X-ray source. In another aspect the invention provides for repositioning a second crystal within the same micro-channel so that images can be collected from the second crystal. The invention also provides a method for allowing data collection at above freezing temperatures. Data collection can also occur at sub-zero temperatures such as that of liquid nitrogen (about −190° C.) or liquid helium (about −270° C.).

The protein can be provided by either vapor-diffusion or micro-batch techniques by controlling evaporation and diffusion between droplets within a channel, the channel comprising an oil, gas or immiscible liquid with aqueous droplets therein. The aqueous droplets can include different solutions which can cause the movement of water from one droplet to the next through the oil, gas or immiscible liquid. Different oils, gases, and immiscible liquids, in any combination, can also be employed causing different diffusion rates between droplets (see, e.g., Zheng et al., 2004b, incorporated herein by reference in its entirety).

This technique can be accomplished using small quantities of solutions (including nanoliter-scale quantities) which allows many separate aqueous droplets to be formed from even a small amount of protein, with each becoming a possible nucleation site for the formation of a crystal. This large number of crystals in turn provides many opportunities for the researcher to expose crystals to X-ray for diffraction. The large number of crystals is helpful as the exposure of crystals to X-rays at room temperature often leads to crystal degradation, but large numbers of isomorphic crystals allow data from different crystals to be compiled in order to form the final crystal structure.

Another unexpected benefit of these techniques is the lack of movement of the crystals. In order to form coherent data sets, it is helpful for the crystal to be as stationary as possible. This technique led to crystals that were unusually stable for crystals in an aqueous environment, which allowed researchers the ability to gain unexpectedly good results with good resolution.

Other aspects of the invention include a method in accordance with the above, wherein the repositioning the crystal with respect to the X-ray source comprises rotating the crystal with respect to the X-ray source by a predetermined amount, and a method wherein rotating the crystal with respect to the X-ray source by a predetermined amount comprises rotating the crystal about 1°. The X-ray source may also be repositioned with respect to the crystal by a predetermined amount, for example 1°.

One method that is sometimes used in determination of a crystal structure is to rotate the crystal by a known amount, and then re-expose the crystal to X-ray diffraction. This further exposure of the crystal can then be compared to nearby images in order to determine the crystal structure. Descriptions of software and methods for accomplishing this are discussed below.

Another aspect comprises a method in accordance with the first wherein X-ray diffraction images comprises at least about 2, 5, 10, 15, 20, 25, 30, 35, 40, 45, or 50 X-ray diffraction images and/or comprises at least 51 X-ray diffraction images, and a method wherein the repositioning the crystal with respect to the X-ray source by a predetermined amount, wherein the positioning, recording, or subjecting occurs at a temperature between about −270° C. (about the temperature of liquid helium) and about 30° C. , −190° C. (about the temperature of liquid nitrogen) and about 20° C., −80° C. and about 10° C., or 0° C. and about 4° C.

X-ray diffraction at room temperature can lead to degradation of a crystal. Previous reports of in situ data collection without cryo-cooling suggest the method is only suitable for weaker “home” X-ray sources (Lopez-Jaramillo et al., 2001), but examples of data collections at synchrotrons exist (Lacy et al., 1998; Reinisch et al., 2000). An aspect of the invention demonstrates that single crystals can provide high resolution, refinable datasets under the intensity of synchrotron radiation. In the case of acute decay or reflection “blindspots” due to crystal orientation, datasets from multiple crystals can be successfully merged for improved completeness. In fact, the higher intensity synchrotron beam coupled with fast readout CCD detectors proves advantages for collecting a maximum amount of data prior to the onset of extensive secondary radiation induced decay.

A further aspect of the invention includes method for acquiring X-ray diffraction images for determining protein structure, the method comprising providing a micro-channel containing an oil, gas or immiscible liquid, wherein the oil, gas or immiscible liquid comprises aqueous droplets, the droplets further comprising a crystal of the protein subjecting the protein crystal to an X-ray source, recording an X-ray diffraction image, repositioning the crystal with respect to the X-ray source so that a second crystal within said micro-channel is subjected to the X-ray source, and repeating.

Compilation of data from two or more crystals in the same micro-channel allows the compilation of data in an efficient way, without the need to mount one or more crystals. Mounting crystals requires handling and movement of the crystal and an advantage of the technique described herein is the ability to subject crystals to diffraction while eliminating several steps of traditional methods. These traditional methods can include some or all of the following steps, removal of crystals from aqueous solution, moving the crystals and manipulating them for mounting, and cryo-cooling the crystals. Some or all of these steps can be eliminated by the instant invention.

The advantages of in situ data collection have been demonstrated before (McPherson, 2000; Lopez-Jaramillo et al., 2001) when most crystal diffraction data were collected in capillaries. Commercial products (Watanabe, 2005) are now offered that can be used for plate-based X-ray exposures, for predicting resolution limit and space group. These products are impractical for complete data collection due to crystal dehydration and obstruction of the X-ray source by the crystal container. In this invention, in situ collection is used in conjunction with a modern crystallization screening technique, where micro-channels are filled with approximately 100 (replicate or unique) 20 nL micro-batch trials via poly(dimethylsiloxane) (PDMS) stamp based micro-fluidics (Chen et al., 2005; Song et al., 2003; Tice et al., 2003; Zheng et al, 2004a). The aqueous “plugs”, containing protein and precipitant, can be separated by immiscible oil, e.g., a fluorocarbon oil, at both ends. This system has been used previously to obtain space group and unit cell information from crystal diffraction at room temperature (Zheng et al., 2004a). In this invention, micro-channels containing plugs comprising crystals are mounted directly in a cold stream set to 4° C. , and multiple frames of diffraction data are collected using synchrotron radiation. Despite the lack of cryo-cooling, sub 2.0 Å datasets and refined models are achievable, and the collection of data from multiple crystals is achieved, given the large number of micro-batch trials in a single channel. This is a large advance in the practical application of high throughput protein structure determination. Also described is the collection of two adjacent crystals.

Methods of the current invention can be used to determine a structure that substantially conforms to a given set of atomic coordinates is a structure wherein at least about 50% of such structure has an average root-mean-square deviation (RMSD) of less than about 3.0 Å for the backbone atoms in secondary structure elements in each domain, and in various aspects, less than about 2.5 Å for the backbone atoms in secondary structure elements in each domain, and, in various aspects less than about 2.0 Å, in other aspects less than about 1.0 Å, less than about 0.5 Å, and, less than about 0.25 Å for the backbone atoms in secondary structure elements in each domain. In one aspect of the present invention, a structure that substantially conforms to a given set of atomic coordinates is a structure wherein at least about 75% of such structure has the recited average RMSD value, and in some aspects, at least about 90% of such structure has the recited average RMSD value, and in some aspects, about 100% of such structure has the recited average RMSD value. In particular, the above definition of “substantially conforms” can be extended to include atoms of amino acid side chains. As used herein, the phrase “common amino acid side chains” refers to amino acid side chains that are common to both the structure which substantially conforms to a given set of atomic coordinates and the structure that is actually represented by such atomic coordinates.

A three dimensional structure of a protein which substantially conforms to a specified set of atomic coordinates can be modeled by a suitable modeling computer program such as MODELER (A. Sali and T. L. Blundell, J. Mol. Biol., vol. 234:779-815,1993 as implemented in the Insight II software package Insight II, available from Accelerys (San Diego, Calif.) and other software packages, using information, for example, derived from the following data: (1) the amino acid sequence of the protein; (2) the amino acid sequence of the related portion(s) of the protein represented by the specified set of atomic coordinates having a three dimensional configuration; and, (3) the atomic coordinates of the specified three dimensional configuration. A three dimensional structure of a protein which substantially conforms to a specified set of atomic coordinates can also be calculated by a method such as molecular replacement.

According to the present invention, a three dimensional structure of a protein can be used to derive a model of the three dimensional structure of another protein (i.e., a structure to be modeled). As used herein, a “structure” of a protein refers to the components and the manner of arrangement of the components to constitute the protein. As used herein, the term “model” refers to a representation in a tangible medium of the three dimensional structure of a protein, polypeptide, or peptide. For example, a model can be a representation of the three dimensional structure in an electronic file, on a computer screen, on a piece of paper (i.e., on a two dimensional medium), and/or as a ball-and-stick figure. Physical three-dimensional models are tangible and include, but are not limited to, stick models and space-filling models. The phrase “imaging the model on a computer screen” refers to the ability to express (or represent) and manipulate the model on a computer screen using appropriate computer hardware and software technology known to those skilled in the art. Such technology is available from a variety of sources including, for example, Accelrys, Inc. (San Diego, Calif.). The phrase “providing a picture of the model” refers to the ability to generate a “hard copy” of the model. Hard copies include both motion and still pictures. Computer screen images and pictures of the model can be visualized in a number of formats including space-filling representations, α-carbon traces, ribbon diagrams and electron density maps.

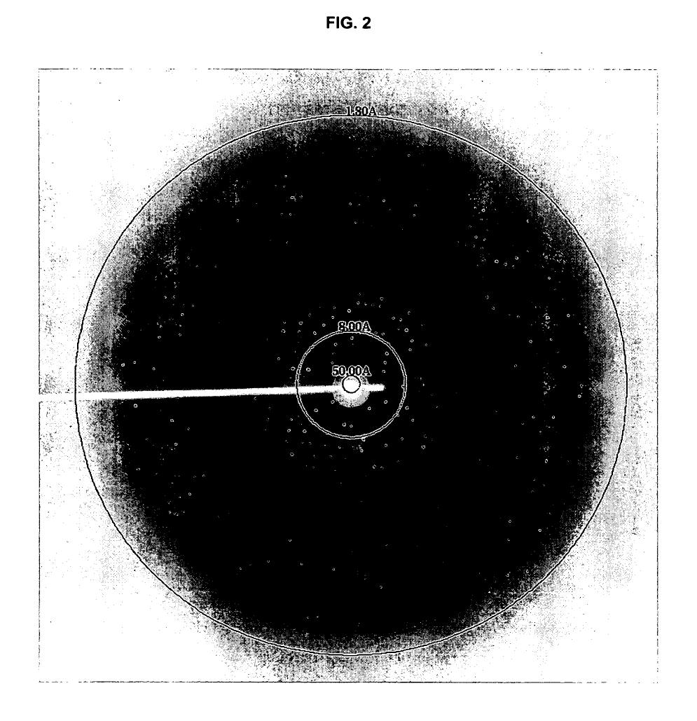

In one aspect the invention has demonstrated an integrated in situ approach to crystallization screening and X-ray data collection for macromolecules. This method is amenable to automated sparse matrix screening (Zheng & Ismagilov, 2005) and gradient fine screening (Zheng et al., 2003). Micro-channels provide convenient handling of multiple crystals for data collection, which can be used to offset the shortened lifetime of exposed crystals without the aid of cryo-cooling. The method was validated by using thaumatin as a model system to the point of providing sub-2.0 Å structures (FIG. 2). The overall approach is well suited towards the automation of macromolecular structure determination.

Plastic Micro-channels

For centuries, glass proved to be the material of choice for all optical applications, including X-ray crystallography. Presently, applications for glass elements and complex optical systems have greatly expanded. Advancements in materials, coupled with improved mold design, have enabled plastic optics to replace glass optics in a wide and growing number of applications. However, glass has remained the material of choice for X-ray crystallography applications because it was thought that the glass allowed for the generation of optimal crystals for structure determination.

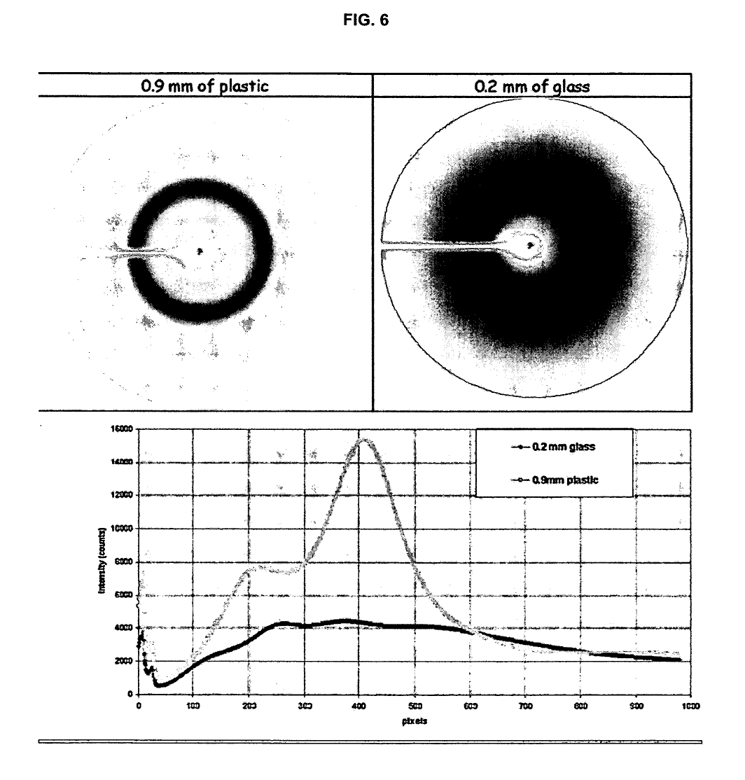

Surprisingly, plastics provide the same resolution as glass as provided in FIG. 6. Preferred plastics formed into micro-channels of the present invention are amorphous. Such plastic micro-channels can be formed in different geometries to work with different apparatus, e.g. microfluidics, configurations. Preferred plastics provide low background and even background scatter when subjected to X-ray radiation. Examples include Cycloolefin polymers (COP), Cycloolefin copolymers (COC), Polymethyl methacrylate (PMMA), or derivatives thereof which are especially useful because such plastics are also amorphous and minimally water permeable.

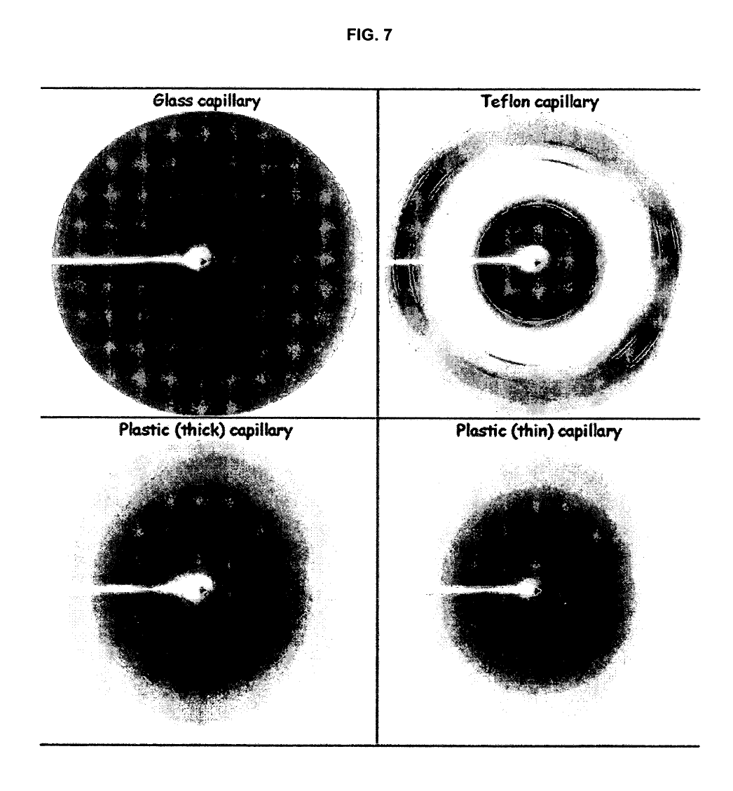

COP and COC plastics are in many cases superior to glass micro-channels because new possibilities in the geometry, design and layout of optical systems can be made. In addition, the plastics of the present invention can provide higher intensity when using a plastic micro-channel, for example a COP plastic micro-channel (FIG. 6), when compared to glass. Additionally, the homogeneity of background scattering when comparing a plastic micro-channel to glass and Teflon® is observed (FIG. 7).

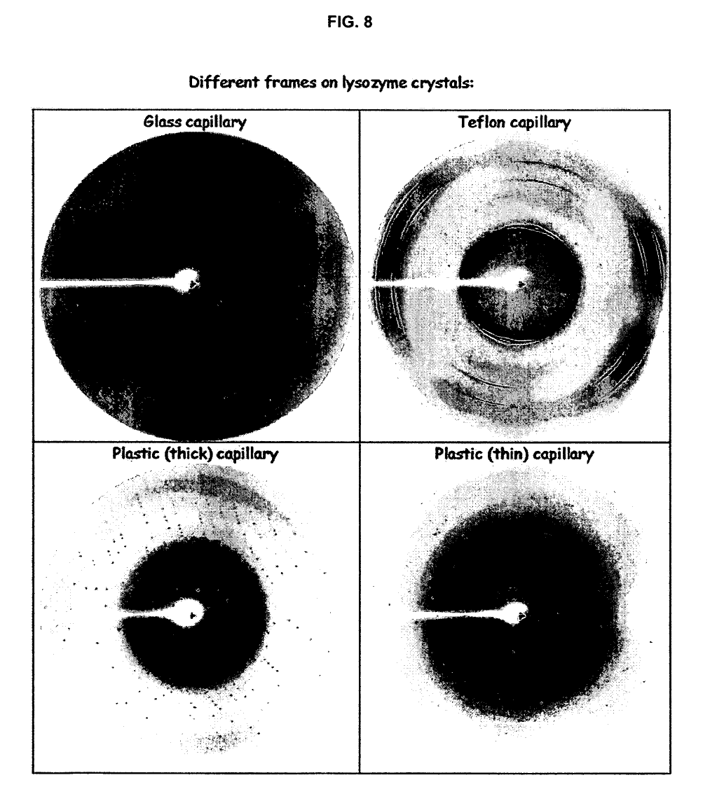

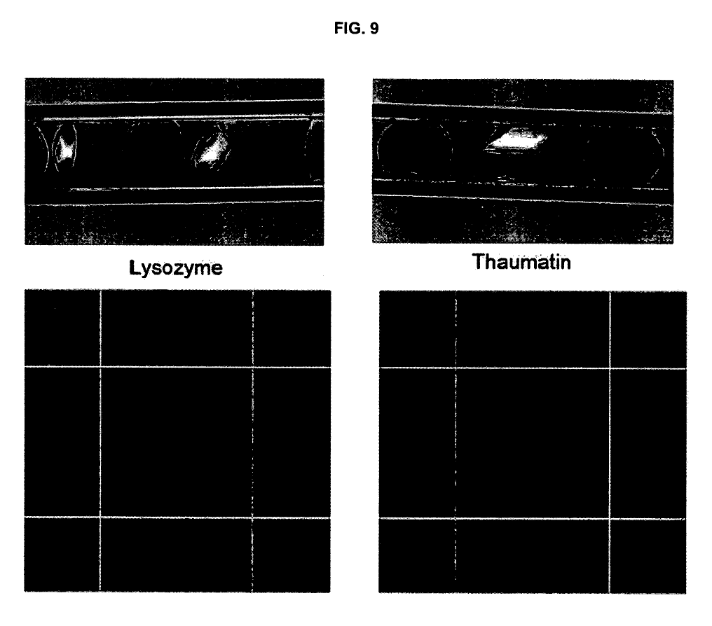

FIG. 8 depicts the resolution quality when comparing glass, Teflon® and COP plastic. It is surprising that the COP background is low when compared to the Teflon® background. Without being bound by a particular theory, it is believed that the ordered structure of the Teflon® create interference when irradiated with X-rays which results in high background as opposed to the amorphous structure of the COP which results in low background. Further, FIG. 9 depicts crystals in a micro-channel, in this case COP plastic tubing, and the crystal images provided by in situ X-ray irradiation and image collection. The tubing on the left panel shows two crystals of lysozyme in the COP tubing and the right panel shows a single thaumatin crystal.

Other optical grade plastics for use in micro-channels includes acrylics, polystyrene, polycarbonate and NAS, a copolymer of 70% polystyrene and 30% acrylic. These plastics, COP, COC and PMMA can be obtained commercially, for example by G-S Plastic Optics, Rochester, N.Y. .

### EXAMPLES

Without further elaboration, it is believed that one skilled in the art can, using the preceding description, utilize the present invention to its fullest extent. The following specific examples are offered by way of illustration and not by way of limiting the remaining disclosure.

### Example 1

### Obtaining Crystal Structure Date from Thaumatin

The micro-channel apparatus was constructed as previously described (Chen et al., 2005; Song et al., 2003; Tice et al., 2003) using PHD 2000 Syringe Pumps (Harvard Apparatus) and 10 and 50 μL Hamilton Gastight syringes (1700 series, TLL). Micro-channels were fabricated using rapid prototyping in PDMS. PDMS was Dow Corning Sylgard Brand 184 Silicone Elastomer, and devices were sealed using a Plasma Prep II (SPI Suppliers).

Thaumatin (Sigma Chemical) was chosen as an initial model protein to demonstrate that the overall approach from crystal growth to data collection was feasible. Crystals were successfully grown using microfluidics by filling a single thin glass channel (Hampton Research) with 100 replicate plugs that contained a 1:1 mixture, by volume, of 2.0 M sodium potassium tartrate and a thaumatin concentration of 25.0 mg/mL. After generating the plugs containing tartrate and thaumatin, the first single crystals (25-50 microns) could be seen within hours. Pictures of micro-channels were taken using a SPOT Insight color camera mounter on a Leica MZ 12 5 stereoscope.

Diffraction data collection was performed at the GM/CA-CAT beamline at the Advanced Photon Source (APS) at 12000 eV (1.03 Å). Capillaries were attached onto stems of pins using HoldFast epoxy aquarium sealant (Marineland), and mounted on the goniometer under a cold stream (CryoJet XL, Oxford Diffraction) set to 4° C.

Two datasets were collected from two crystals in adjacent plugs at 1.0° oscillation and 1.2 s exposure per frame, with the unfocused beam attenuated by 50%.

As disclosed in Table 1, diffraction data statistics for two thaumatin crystals in the same channel. Refined unit cell parameters were virtually identical in both crystals with a=b=58.6 Å, c=151.93 Å in P4₁2₁2. Rᵢₙₜ of merging Datasets 1 and 2 was 0.04. The outer resolution shell for the initial frame in Dataset 1 was 1.75 Å-1.61 Å, and for the final frame it was 2.10-2.0 Å. Corresponding ranges for Dataset 2 were 1.75 Å-1.61 Å, 1.80-1.69 Å.

TABLE 1

| | Dataset | | |
|---|---|---|---|
| | 1 | 2 | Merged |
| Resolution Range (Å) | 27.94-1.86 | 36.34-2.00 | 36.34-1.86 |
| Number of Reflections | 20717 | 18350 | 21731 |
| Completeness (%) | 94.1 | 99.4 | 98.7 |
| Completenessₒᵤₜₑᵣ (%) | 94 | 99.2 | 94 |
| Redundancy | 7.9 | 7.3 | |
| Initial Frame I/σ(I) | 9.11 | 7.94 | |
| Final Frame I/σ(I) | 6.48 | 5.89 | |
| Initial Frame I/σₒᵤₜₑᵣ(I) | 2.96 | 2.64 | |
| Final Frame I/σₒᵤₜₑᵣ(I) | 1.38 | 1.28 | |
| I/σ(I) | 24.07 | 22.0 | 30.56 |
| I/σₒᵤₜₑᵣ(I) | 10.69 | 10.05 | 10.69 |
| R_{sym} | 0.086 | 0.094 | |
| R | 0.145 | 0.146 | 0.148 |
| R_{free} | 0.187 | 0.195 | 0.188 |
| Number of Frames | 100 | 100 | |

Data were integrated and scaled in HKL 2000 (Otwinowski & Minor, 1997) and the merged dataset was produced using XPREP (Bruker AXS). Molecular replacement (using Protein Data Bank identification number 1THW as a model, available at http://www.rcsb.org/pdb/) was carried out using MOLREP, refinement using REFMAC5 (Murshudov et al., 1997) and solvent building using ARP/wARP (Perrakis et al., 1997) of the CCP4 (1994) suite of programs.

Thaumatin has been refined up to 1.05 Å (Protein Data Bank identification number 1 RQW), and crystals grown in agarose gel have provided room temperature datasets from synchrotron radiation yielding 1.2 Å resolution atomic models (Sauter et al., 2002), but the crystals used in this study are about a tenth of the scale of those used by Sauter et al. The observed diffraction limits of about 2.0 Å may be due, at least in part, to short, highly attenuated exposures and progressive weakening of the outer shell of reflections from radiation induced decay. The I/σ(I)outer values decrease about 2 fold between the initial and final frames for each dataset, and the outer shell limits themselves drop in resolution. As a control experiment, several flash cryo-cooled thaumatin crystals were prepared using hanging drop vapor diffusion conditions analogous with the micro-channel conditions using glycerol as a cryo protectant. No crystal (despite being much larger than those in the micro-channels) exceeded a visible diffraction limit of 1.7 Å (under similar exposure times).

In order to limit secondary damage, no attempt was made to choose a starting point for data collection by strategy simulations. Instead, 100 degrees of data were collected at random orientation. Dataset 1 was processed to 2.0 Å, and it was discovered that it had only 94% completeness in spite of collecting 100 degrees of data from a tetragonal crystal. The channel was then translated along the goniometer z-axis and a fresh crystal was recentered in the beam. An additional 100 frames were collected on a second crystal (which was processed to 1.9 Å), and the datasets were merged to form a virtually complete dataset, with higher redundancy and resolution. The thaumatin model was refined against this dataset to achieve R-factors about as low as any entry found in the Protein Data Bank for thaumatin (in the same tetragonal space group and at a comparable resolution). Minimally complete datasets (merged and unmerged), also yielded virtually identical R-factors and no striking differences in electron densities are observed. Isomorphic crystals are an important underlying assumption for the micro-channel approach. The use of multiple, isomoprhic crystals does not offer any inherent disadvantage in data quality, but modern protein crystallographers seem to be apprehensive about introducing errors from subtle non-isomorphisms. Virus crystallographers routinely use multiple crystals (see Grimes et al., 1998 for an example of 1000 crystals) for merged datasets.

As an initial proof of concept, experiments were biased towards large crystals of thaumatin (100 micron scale), offsetting primary radiation damage effects which are independent of temperature. For crystals of this size, the total radiation exposures required for minimally complete datasets are well below the Henderson (1990) limit. Secondary damage from the diffusion of reactive radiolytic products is likely to be a much larger effect in the case of non-frozen micro-channels, than it is in flash cryo-cooled experiments. Secondary damage was minimized and local heating effects by setting the cold stream to 4° C. Despite these measures as expected, diffraction spots weakened much more rapidly than would be observed under cryo-conditions. This can be observed in both datasets by the decreasing overall intensities for each frame, and in the decreased signal to noise ratios of the outer shell of reflections between the initial and final frames.

An indicator of radiation induced damage is that measured intensities decrease significantly as the X-ray dose accumulates. The individual R_{sym} values for the datasets (8.6% and 9.4%) could be considered large, but in addition to decay, could be due to temperature shifts in the cold stream and/or expected increased sensitivity to vibrations from low mosaicity (initial mosaicities are 0.056 degrees and 0.049 degrees). Mosaicity has a constant drift throughout the frames, but drifts for other integration parameters are small. The final difference in unit cell lengths for both datasets is only about 0.1%. There is no clear inflection point or threshold that would indicate a reasonable frame at which to cutoff the integration. The two datasets were merged with a low Rᵢₙₜ (4%), and are free of the non-isomorphism that can be introduced from flash cryo-cooling (Teng & Moffat, 2000).

It is difficult to estimate exactly how the decay process affects the quality of the dataset, given the low R-factors for the refined model. Disulfide bonds, known to be susceptible to radiation-induced reduction, have faithful electron density in the refined thaumatin maps. Some glutamate side chains in each structure demonstrate carboxylate electron density that is less precise than other parts of the model, but it is difficult to determine if this is due to decarboxylation.

### Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which does not depart from the spirit or scope of the present inventive discovery. Such modifications are also intended to fall within the scope of the appended claims.

### REFERENCES CITED

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

Other publications incorporated herein by reference in their entirety include:

Blake, C. C. F. & Phillips, D. C. (1962). Proceedings of the Symposium on the Biological Effects of Ionizing Radiation at the Molecular Level, Brno, IAEA Symposium, Vienna, pp.183-191.

Chen, D. L., Gerdts, C. J. & Ismagilov, R. F.(2005). J. Am. Chem. Soc. (in press).

COLLABORATIVE COMPUTATIONAL PROJECT, NUMBER 4. (1994). Acta Cryst. D50, 760-763.

Grimes, J. M., Burroughs, J. N., Gouet, P., Diprose, J. M., Malby, R., Zientara, S., Mertens, P. P. & Stuart, D. I. (1998). Nature, 395, 470-478.

Hansen, C. L., Skordalakes, E., Berger, J. M. & Quake, S. R. (2002). PNAS, 99, 16531-16536.

Henderson, R. (1990). Proc. R. Soc. London, B241, 6-8.

Lacy, D. B., Tepp, W., Cohen, A. C., DasGupta, B. R. & Stevens, R. C. (1998). Nat. Struct. Biol. 5(10), 898-902.

López-Jaramillo, F. J., Garcia-Ruiz, J. M., Gavira, J. A. & Toálora, F. (2001). J. Appl. Crystallogr.. 34, 365-270.

McPherson, A., (2000). J. Appl. Crystallogr. 33, 397-400.

McPhillips, T. M., McPhillips, S. E., Chiu, H.-J., Cohen, A. E., Deacon, A. M., Ellis, P. J., Garman, E., Gonzalez, A., Sauter, N. K., Phizackerley, R. P, Soltis, S. M. & Kuhn, P. (2002). J. Synchrotron Rad., 9, 401-406.

Murshudov, G. N., Vagin, A. A. & Dodson, E. J. (1997). Acta Crystallogr. D53, 240-255.

Otwinowski, Z. & Minor, W. (1997). Meth. in Enz (Carter, C. & Sweet, B. eds.), 276, 307-326.

Perrakis, A., Sixma, T. K., Wilson, K. S. & Lamzin, V. S. (1997). Acta Crystallogr. D53, 448-455.

Reinisch, K. M., Nilbert, M. L. & Harrison, S. C. (2000). Nature, 404, 960-967.

Sauter, C., Lorber, B. & Giegé, R. (2002). Proteins: Struct., Funct., Genet., 48, 146-150.

Song, H., Tice, J. D. & Ismagilov, R. F. (2003). Angew. Chem., Int. Ed. 42, 768-772.

Teng, T. & Moffat, K. (2000). J. Sychrotron Rad. 7, 313-317.

Tice, J. D., Song, H., Lyon, A. D. & Ismagilov, R. F. (2003). Langmuir, 19 (22), 9127-9133.

Watanabe, N. (2005). J. AppI. Crystallogr. 38, 396-397.

Yagi, N., Inoue, K. & Oka, T. (2004). J. Synchrotron Rad. 11, 456-461.

Yonath, A., Harms, J., Hansen, H. A., Bashan, A., Schluenzen, F., Levin, I., Koelln, I., Tocilj, A., Agmon, I., Peretz, M., Bartels, H., Bennett, W.S., Krumbholz, S., Janell, D., Weinstein, S., Auerbach, T., Avila, H., Piolleti, M., Morlang, S. & Franceschi, F. (1998). Acta Crystallogr. A54, 945-955.

Zheng, B., Roach, L. S. & Ismagilov, R. F. (2003). J. Am. Chem. Soc. 125, 11170-11171.

Zheng, B., Tice, J. D., Roach, L. S. & Ismagilov, R. F. (2004). Angew. Chem., Int. Ed. 43, 2508-2511.

Zheng, Joshua D. Tice, and Rustem F. Ismagilov, “Formation of Arrayed Droplets by Soft Lithography and Two-Phase Fluid Flow, and Application in Protein Crystallization”, Adv. Mater. 2004 16:1365-1368.

Zheng, B.& Ismagilov, R. F. (2005). Angew. Chem., Int. Ed. 117, 2576-2579.

Ng J. D., Gavira J. A. & Garcia-Ruiz J. M. (2003). J. Struct. Biol. 142, 218-213.

What is claimed is:

1. A method for acquiring X-ray diffraction images of a protein crystal, the method comprising:
a) providing an X-ray source and a micro-channel, wherein the micro-channel contains at least one aqueous droplet comprising a crystal of a protein and an oil, gas or immiscible liquid;
b) recording an X-ray diffraction image of the crystal;
c) repositioning the crystal with respect to the X-ray source; and
d) repeating b) and c) at least once.

2. A method in accordance with claim 1, wherein the repositioning the protein crystal with respect to the X-ray source comprises rotating the protein crystal with respect to the X-ray source by a predetermined amount.

3. A method in accordance with claim 2, wherein the rotating the protein crystal with respect to the X-ray source by a predetermined amount comprises rotating the crystal about 1°.

4. A method in accordance with claim 1, wherein X-ray diffraction images comprise at least about 10 X-ray diffraction images.

5. A method in accordance with claim 1, wherein X-ray diffraction images comprise at least 51 X-ray diffraction images.

6. A method in accordance with claim 2, wherein the repositioning the protein crystal with respect to the X-ray source by a predetermined amount comprises rotating the micro-channel by a predetermined amount.

7. A method in accordance with claim 1, wherein the positioning occurs at a temperature between about −170° C. and 30° C.

8. A method in accordance with claim 1, wherein the recording occurs at a temperature between about −120° C. and 20° C.

9. A method in accordance with claim 1, wherein the repositioning occurs at between about −80° C. and 10° C.

10. A method for acquiring X-ray diffraction images of a protein crystal, the method comprising:
a) providing an X-ray source and a micro-channel, wherein the micro-channel contains at least two aqueous droplets and an oil, gas or immiscible liquid and, further wherein each droplet comprises a protein crystal;
b) recording an X-ray diffraction image of a first protein crystal comprised by the micro-channel;
c) repositioning the micro-channel with respect to the X-ray source such that a second or greater protein crystal comprised by the micro-channel is subjected to the X-ray source;
d) recording an X-ray diffraction image of the second or greater protein crystal comprised by the micro-channel; and
e) repeating c) and d) at least once.

11. A method in accordance with claim 10, wherein the positioning occurs at a temperature between about −170° C. and 30° C.

12. A method in accordance with claim 10, wherein the recording occurs at a temperature between about −120° C. and 20° C.

13. A method in accordance with claim 10, wherein the repositioning occurs at between about −80° C. and 10° C.

14. A method in accordance with claim 10, wherein X-ray diffraction images comprise at least about 10 X-ray diffraction images.

15. A method in accordance with claim 10, wherein X-ray diffraction images comprise at least 51 X-ray diffraction images

16. A method for determining a three dimensional structure of a protein, the method comprising:
a) providing an X-ray source and a micro-channel, the micro-channel containing at least one aqueous droplet comprising a crystal of a protein and an oil, gas or immiscible liquid;
b) recording an X-ray diffraction image of the crystal;
c) repositioning the crystal with respect to the X-ray source;
d) repeating b) and c) at least once; and
e) transforming the X-ray diffraction images to assign coordinates to atoms comprised by the protein.

17. A method according to claim 16, further comprising:
f) representing the atoms in a three dimensional structure in a digital medium.

18. A method for designing a drug, the method comprising:
a) providing an X-ray source and a micro-channel, wherein the micro-channel contains at least one aqueous droplet comprising a crystal of a protein and an oil, gas or immiscible liquid;
b) recording an X-ray diffraction image of the crystal;
c) repositioning the crystal with respect to the X-ray source;
d) repeating b) and c) at least once;
e) transforming the X-ray diffraction images to assign coordinates to atoms comprised by the protein;
f) representing the atoms in a three dimensional structure in a digital computer; and
g) using software comprised by the digital computer to design a chemical compound which is predicted to bind to the protein.

19. A method for acquiring X-ray diffraction images of a crystal of a protein-ligand complex, the method comprising:
a) providing an X-ray source and a micro-channel, wherein the micro-channel contains at least one aqueous droplet comprising a crystal of a protein-ligand complex and an oil, gas or immiscible liquid;
b) recording an X-ray diffraction image of the crystal;
c) repositioning the crystal with respect to the X-ray source; and
d) repeating b) and c) at least once.

20. A plastic micro-channel comprising two or more aqueous droplets each comprising a protein crystal, said droplets separated by an oil, gas or immiscible liquid.

21. A plastic micro-channel according to claim 20, wherein the plastic is selected from the group consisting of COP, COC, PMMA, acrylic, polystyrene, polycarbonate and NAS.

22. A plastic micro-channel according to claim 20, wherein in addition to at least two aqueous droplets comprising protein crystals separated by an oil, at least one additional aqueous droplet comprising a protein crystal is separated by a gas.

23. A plastic micro-channel according to claim 20, wherein at least two crystals comprise the same macromolecule.

24. A plastic micro-channel according to claim 20, wherein at least two crystals comprise different macromolecules.
